(19) United States
(12) Patent Application Publication
(10) Pub. No.: US 2016/0305974 A1
(43) Pub. Date: Oct. 20, 2016

(54) AUTOMOTIVE SENSOR ACTIVE TEMPERATURE CONTROL AND TEMPERATURE FAULT MONITORING

(71) Applicant: IMT PARTNERSHIP, Ingersoll (CA)

(72) Inventors: Timothy David Webster, Burnaby (CA); ASHU M. SOLO, Saskatoon (CA)

(73) Assignee: IMT PARTNERSHIP, Ingersoll, ON (CA)

(21) Appl. No.: 15/032,027

(22) PCT Filed: Oct. 27, 2014
(86) PCT No.: PCT/CA2014/000776

§ 371 Date: Apr. 25, 2016

Related U.S. Application Data
(60) Provisional application No. 62/068,929, filed on Oct. 27, 2014.
(60) Provisional application No. 61/895,863, filed on Oct. 25, 2013.

(51) Int. Cl. G01P 1/00; F16D 65/84; B60T 17/22; G01P 3/44; G07C 5/08

(52) U.S. Cl. CPC G01P 1/006; G01P 3/44; G07C 5/0816; B60T 17/22; F16D 65/84; F16D 2065/783

(57) ABSTRACT

The present invention has a controller (010) to monitor the environmental temperature of automotive or industrial sensor (830) and a means of actively heating (651) or cooling (520) sensors such that the sensor (830) is not exposed to extreme cold or hot temperatures, which could negatively affect the operation of the sensor (830) either temporarily or permanently. The operator (901) is informed (356) of the future probability of measurable degraded performance of the automotive or industrial machine or thermal stress of sensors to enable the operator (901) to adjust her operation (910) of the machine and perform preventive maintenance to reduce the future probability of measurable degraded performance and thermal stress of sensor (830). There can be a plurality of sensors.

### BACKGROUND OF THE INVENTION

1. Field of Invention

This invention relates to using a wheel speed sensor with an integrated temperature sensor to monitor brake heat applied to the wheel speed sensor, thereby enabling active cooling of the wheel speed sensor and/or brakes, enabling the driver to adjust their driving style to reduce brake heat and wear, and enabling detection and prediction of failures of wheel speed sensor and brakes caused by extreme brake temperatures.

2. Description of Prior Art

Variable reluctance sensors with integrated temperature sensors (for example, WIPO patent no. WO2005047838) do not provide a means of actively cooling the wheel speed sensor, providing driver feedback, or detecting and predicting failures of the wheel speed sensor and brakes.

Wheel speed sensor mounting arrangements (for example, U.S. patent no. US2005206148) do not include a means of monitoring heat applied to the wheel speed sensor or a means of actively cooling the wheel speed sensor.

Combined hub temperature and wheel speed sensor systems that monitor wheel bearing temperature (for example, U.S. Pat. No. 6,538,426) do not provide a means of actively cooling the wheel speed sensor.

A vehicle with brake temperature monitoring and systems to provide warnings and disengage active stability systems utilizing brakes (for example, EPIO patent no. EPO489887A1) does not provide a means of actively monitoring wheel speed sensor temperature or provide a means of actively cooling brakes or wheel speed sensors.

### SUMMARY OF THE INVENTION

The temperature environment of the electronic automotive sensors and the automotive operation measured by the electronic automotive sensors is preferably monitored to inform the operator of electronic automotive sensors exposed to extreme thermal environment affecting the reliability of the electronic automotive sensor measurements and to inform the operator of degraded performance of the automotive system monitored by the electronic automotive sensors.

The temperature of the environment of the electronic automotive sensors is preferably controlled to prevent temperatures from occurring outside the allowable temperature range of the electronic automotive sensors, which protects them from thermally induced degraded performance or damage.

Magnetic wheel speed sensors operating in extreme thermal environment are preferably actively cooled and heated as required to keep these sensors operating within their operating temperature range.

Data collected through measuring the operation of the active cooling and heating apparatus is preferably used to monitor the automotive braking system and to detect and report degraded performance.

Modular subcontrollers are preferably used to allow subcontrollers to monitor each other and provide redundancy when highly reliable monitoring and active cooling is required.

Retention of temperature sensor and electronic automotive sensor measurements are preferably used in combination with centralized machine learning to detect patterns and probabilistically classify measurements according to the future probability of degraded performance and thermal environment outside the operating range of electronic automotive sensors.

When there is a high future probability of degraded performance and thermal environment outside the operating range of the electronic automotive sensors, the operator is preferably alerted.

The operator is preferably able to adjust the operating behaviour of the electronic automotive sensors or of the temperature environment and to perform adjustments or perform preventive maintenance to reduce the future probability of degraded performance and thermal environment outside the operating range of the electronic automotive sensors. Still further objects and advantages will become apparent from a consideration of the ensuing description and drawings.

The present invention is a system to monitor the environmental temperature of automotive or industrial sensors and a means of actively heating or cooling sensors such that the sensor is not exposed to extreme cold or hot temperatures, which could negatively affect the operation of the sensor either temporarily or permanently. The operator is preferably informed of the future probability of measurable degraded performance of the automotive or industrial machine or thermal stress of sensors to enable the operator to adjust her operation of the machine and perform preventive maintenance to reduce the future probability of measurable degraded performance and thermal stress of sensors.

A system to monitor and control the environmental temperature of automotive sensors comprises a sensor assembly having an electronic automotive sensor an temperature sensor that are located in close proximity to one another. A system further has means of actively controlling or heating the electronic sensor according to an temperature operating range of electronic automotive sensor and a controller that uses the temperature sensor to monitor the temperature of the electronic automotive sensor and acts to control the means of actively cooling or heating the electronic automotive sensor to maintain the electronic automotive sensor within its temperature operating range. Damage to the electronic automotive sensor and measurement inaccuracy caused by temperatures outside the temperature operating range of the electronic automotive sensor is reduced by the controller controlling the means of actively calling or heating the electronic automotive sensor.

A method of operating a system to monitor and control the environmental temperature of automotive sensors having a sensor assembly with an electronic automotive sensor and temperature sensor located in proximity to each other, with means of actively cooling or heating the electronic automotive sensor according to a temperature operating range of the electronic automatic sensor, with a controller to operate and control the system, the method comprising having the controller use the temperature sensor to monitor the temperature of the electronic automotive sensor and activating the means to cool or heat the electronic automotive sensor to maintain the electronic automotive sensor within its temperature operating range, thereby reducing any damage to the electronic automotive sensor that would be caused by operating at temperatures outside the temperature operating range.

### BRIEF DESCRIPTION OF THE DRAWINGS

The advantages of this invention may be better understood by reading the following description as well as the accompanying drawings where numerals indicate the structural elements and features in various figures. The drawings are not necessarily to scale, and they demonstrate the principles of the invention.

FIG. 1 is a block diagram of a prior art wheel speed sensor assembly 030 and wheel speed sensor controller 010;

FIG. 2 is a block diagram of a wheel speed sensor assembly 030 and wheel speed sensor controller 010 with active cooling of the wheel speed sensor assembly 030 controlled by the wheel speed sensor controller 010;

FIG. 3 is a block diagram of a wheel speed sensor assembly 030 and wheel speed sensor controller 010 with active cooling of the wheel speed sensor assembly 030 and lift/lock axle control valves 042 controlled by controller designed to meet the Ontario, Canada SPIF requirements;

FIG. 4 is a block diagram of a wheel speed sensor assembly 030 and wheel speed sensor controller 010 with active cooling, further including additional secondary sensors to provide alive checks and environmental monitoring;

FIG. 5 is a flow diagram of the main control loop of an embodiment of the present invention;

FIG. 6 is a flow diagram of the secondary sensor control loop monitoring and controlling the primary sensor environment;

FIG. 7 is the state transition table which maps the resolved current and previous states to valid actions or error type and used in main control loop described in FIG. 5;

FIG. 8 is a flow diagram of the operator interaction with electronic automotive sensors with integrated temperature sensors 830;

FIG. 9 is a flow diagram of the detection of operation trend patterns from electronic automotive sensors and temperature sensors;

FIG. 10 is the diagram of a wheel speed sensor assembly 030 and wheel speed sensor controller 010, shown in FIG. 4 further including distributed resistive heater controllers 011 and active cooling air flow controllers 012.

### DRAWINGS

### Reference Numerals

010—wheel speed sensor and steering axle controller
011—resistive heater controller
012—active cooling air flow controller
020—air supply
030—wheel speed sensor assembly
040—air flow control valve
042—lift/lock axle control valves
050—magnetic encoder ring
110—external signal wires connecting the wheel speed sensor 030 and the wheel speed sensor controller 010
111—signal wires connecting the air spring pressure sensor with integrated temperature sensor 650 to the wheel speed sensor and steering axle controller 010
112—signal wires connecting the air supply pressure sensor with integrated temperature sensor 610 to the wheel speed sensor and steering axle controller 010
113—communication wires connecting the resistive heater controller 011 associated with the supply pressure sensor heating resistor 611
114—communication wires connecting the resistive heater controller 011 associated with air spring pressure sensor heating resistor 651
115—communication wires connecting the active cooling air flow controller 012 associated with the air supply pressure sensor with integrated temperature sensor 650
120—solenoid power wires connecting the air flow control value 040 and the wheel speed sensor controller 010
121—solenoid power wires connecting the lift/lock axle control valves 042 and the wheel speed sensor controller 010
125—air flow solenoid current measurement
126—wheel speed sensor current measurement
127—lift/lock axle solenoids current measurements
130—wheel speed and temperature signal wires connecting wheel speed sensor, temperature sensor 830 to external signal wires 110
131—wheel speed signal wires connecting wheel speed sensor 831 to external signal wires 110
210—air line from air supply 020 to air flow control valve 040
220—air line from air flow control valve 040 to wheel speed sensor air shroud 520
230—air line from air spring 660 to air spring pressure sensor with integrated temperature sensor 650
231—air line from air supply 020 to air supply pressure sensor with integrated temperature sensor 610
240—air line from air flow control valve 040 to wheel speed sensor air shroud 520
311—read sensors
312—resolve sensor readings into current compound state
313—read previous compound state
314—classify compound state transition as valid actions or error types
315—invalid state transition error handler
317—read previous error type
319—error message reporting and error visual indication
343—monitoring environmental operating limits of primary loads
351—primary sensors required for resolving the controlled system states
352—primary sensors analog and digital alive checks
353—monitoring environmental operating limits of primary sensors
356—alerting environment of primary sensors
360—active cooling off
361—active cooling on
363—active cooling temperature limits
370—active heating off
371—active heating on
373—active heating temperature limits
500—wheel speed sensor assembly
510—air flow
520—air shroud and wheel speed sensor mounting encasement
530—air shroud 520 air entrance
540—air shroud 520 air exit
601—wheel speed sensor controller heating resistor
610—supply pressure sensor with integrated temperature sensor
611—supply pressure sensor heating resistor
650—air spring pressure sensor with integrated temperature sensor
651—air spring pressure sensor heating resistor
660—air spring
820—electrical insulation of the wheel speed sensor signal wires
830—magnetic wheel speed sensor with integrated temperature sensor
831—magnetic wheel speed sensor
901—operator
902—operation monitor
904—temperature alert monitor
910—operator command interface
926—classifier training and machine learning

### DETAILED DESCRIPTION

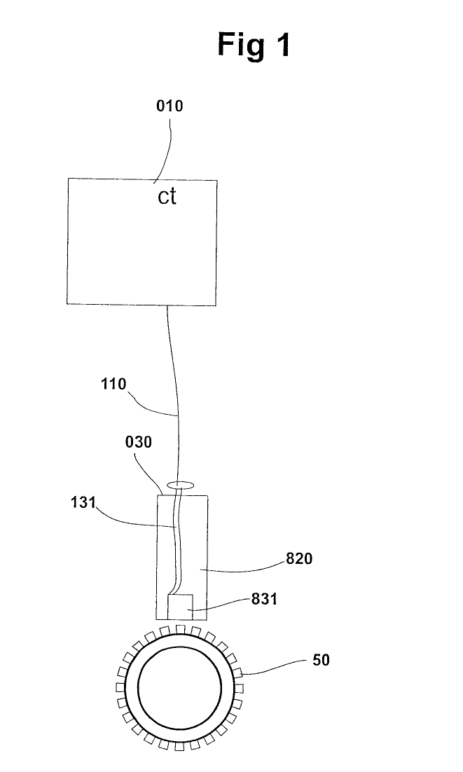

FIG. 1 is a diagrammatic view of the prior art wheel speed sensor assembly 030 with the wheel speed sensor controller 010. The internal wheel speed signal wires 131 connect the wheel speed sensor 831 to the external signal wires 110. The external signal wires 110 connect the wheel speed sensor assembly 030 to the wheel speed sensor controller 010. The controller 010 is preferably a programmable controller and still more preferably one or more of a computer processor, a programmable gate array and an application specific integrated circuit or any combination thereof. The internal wheel speed signal wires 131 are protected from the environment by electrical insulation 820. The magnetic wheel speed sensor 831 is located at the tip of the wheel speed sensor assembly 030 so that it is in close proximity to the magnetic encoder ring 050. The wheel speed sensor 831 is in close proximity to a magnetic encoder ring 050 as required to provide a magnetic field strength sufficient for reliable detection of wheel speed.

The wheel speed sensor 831 can detect wheel speed movement by either a Hall effect sensor or a variable reluctance sensor.

A Hall effect sensor is a transducer that varies its output voltage in response to a magnetic field. The magnetic encoder ring 050 varies magnetic field to create proximity switching. A Hall effect sensor is combined with circuitry that allows the device to act in a digital (on/off) mode.

A variable reluctance sensor consists of a permanent magnet, a ferromagnetic pole piece, a magnetic pickup, and a rotating toothed wheel. The amount of magnetic flux passing through the magnet and consequently the coil varies as the teeth of the magnetic encoder ring 050 pass by the face of the magnet. When the gear tooth is close to the sensor, the flux is at a maximum. When the tooth is further away, the flux drops off. The moving target results in a time-varying flux that induces a proportional voltage in the coil. Subsequent electronics are then used to process this signal to get a digital waveform that can be more readily counted and timed. The frequency and amplitude of the analog signal is proportional to the target's velocity. This waveform needs to be squared up, and flattened off by a comparator like electronic chip to be digitally readable. While discrete VR sensor interface circuits can be implemented, the semiconductor industry also offers integrated solutions.

The material limitations of variable reluctance and Hall effect sensors used as the sensing device of the wheel speed sensor 831 generally restrict the operating temperatures to between −40 C and +150 C. Wheel speed sensors 831 with lower and higher operating temperatures such as −200 C to +450 C exist. These wheel speed sensors with higher operating temperatures are more expensive and require more expensive signal processing. However during emergency braking, disc brake temperatures in excess of +700 C are common. In designs where the wheel speed sensor 831 is in close proximity to the disc brake prior art wheel speed sensor 831 will experience operating temperatures in excess of +150 C and will even experience op crating temperatures in excess of +450 C.

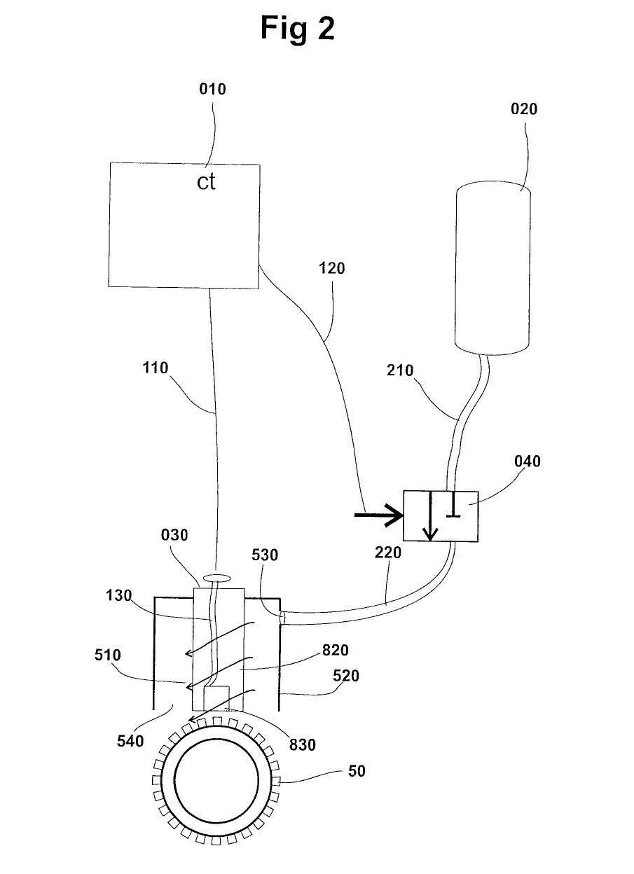

FIG. 2 is a diagrammatic view of the wheel speed sensor assembly 030 with active cooling and wheel speed controller 010. The internal wheel speed and temperature signal wires 130 connect the wheel speed sensor with integrated temperature sensor 830 to the external signal wires 110. The external signal wires 110 connect the wheel speed sensor assembly 030 to the wheel speed sensor controller 010. The internal wheel speed signal wires 130 are protected from the environment by electrical insulation 820. The magnetic wheel speed sensor with integrated temperature sensor 830 is located at the tip of the wheel speed sensor assembly 030 so that it is in close proximity to the magnetic encoder ring 050. The magnetic encoder ring 050 and the magnetic wheel speed sensor 830 is in close proximity to the magnetic encoder ring 050. The wheel speed sensor assembly 030 is enclosed inside an air shroud 520. The air shroud 520 is the wheel speed sensor mounting encasement. An air line 220 is connected between the air shroud entrance 530 and the air flow valve 040. The air flow valve 040 is connected to the air supply 020 by an air line 210. The air flow valve 040 is opened and closed by its solenoid electrically connected to the wheel speed sensor controller 010, by solenoid power wires 120. The wheel speed sensor controller 010 opens the air flow valve 040 by powering the air flow valve 040 solenoid through the solenoid power wires 120. The open air flow valve 040 allows air to flow from the pressurized air supply 020 through the air line 210, through the air valve 040, through the air line 220 into the air shroud 520 by the air shroud entrance 530. Air flow 510 from the air shroud entrance 530 circulates inside the air shroud 520, cooling the wheel speed sensor assembly 030 before exiting out the air shroud exit 540. Air exiting the air shroud exit 450 is directed towards the magnetic encoder ring 050. The magnetic encoder ring 050 creates a varying magnetic field for the magnetic sensor within the wheel speed sensor with integrated temperature sensor 830 to measure wheel speed.

This air flow over the magnetic encoder ring 050 provides air cooling of magnetic encoding ring 050, which reduces radiate heating of the wheels speed sensor assembly 030 by a hot magnetic encoder ring 050. By cooling the wheel speed sensor assembly 030, the wheel speed sensor with integrated temperature sensor 830 is also cooled. Therefore, by cooling or heating a first component, an electronic automotive sensor is also cooled.

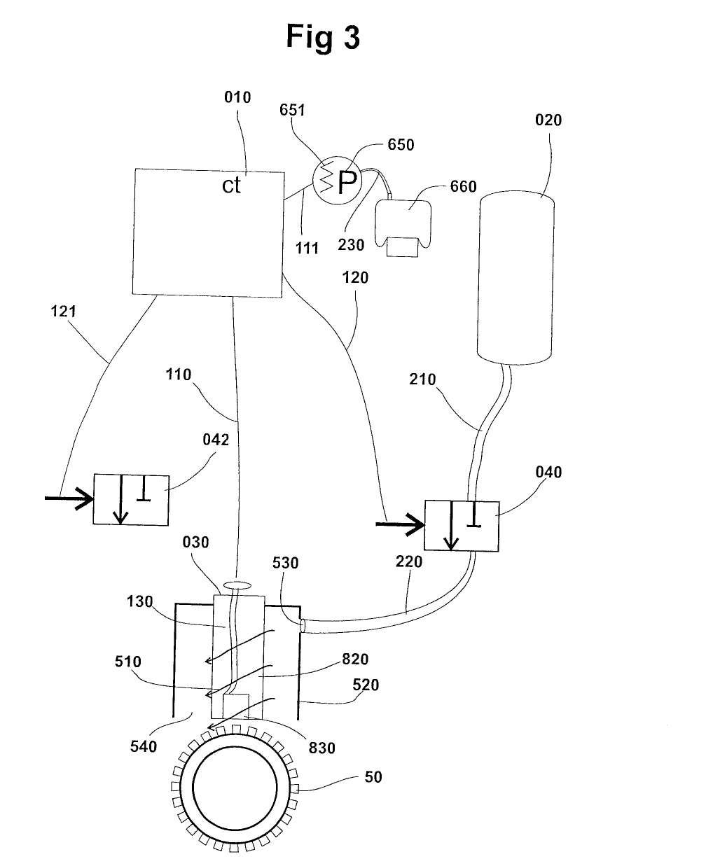

FIG. 3 is a diagrammatic view of the wheel speed sensor assembly 030 with active cooling, and lift/lock axle control valves actuated by the wheel speed controller 010. The internal wheel speed and temperature signal wires 130 connect the wheel speed sensor with integrated temperature sensor 830 to the external signal wires 110. The external signal wires 110 connect the wheel speed sensor assembly 030 to the wheel speed sensor controller 010. The internal wheel speed signal wires 130 are protected from the environment by electrical insulation 820. The magnetic wheel speed sensor with integrated temperature sensor 830 is located at the tip of the wheel speed sensor assembly 030 so that it is in close proximity to the magnetic encoder ring 050. The wheel speed assembly 030 temperature measured by the wheel speed sensor with integrated temperature sensor 830. The measured wheel speed assembly 030 temperature is communicated through signal wire 130 and 110 to the controller 010. The magnetic encoder and the magnetic wheel speed sensor 830 is in close proximity to the magnetic encoder ring 050. The wheel speed sensor assembly 030 is enclosed inside an air shroud 520. The air shroud 520 is the wheel speed sensor mounting encasement. An air line 220 is connected between the air shroud entrance 530 and the air flow valve 040. The air flow valve 040 is connected to the air supply 020 by an air line 210. The air flow valve 040 is opened and closed by its solenoid electrically connected to the wheel speed sensor controller 010, by solenoid power wires 120. The wheel speed sensor controller 010 opens the air flow valve 040 by powering the air flow valve 040 solenoid through the solenoid power wires 120.

The open air flow valve 040 allows air to flow from the pressurized air supply 020 through the air line 210, through the air valve 040, through the air line 220 into the air shroud 520 by the air shroud entrance 530. Air flow 510 from the air shroud entrance 530 circulates inside the air should 520, cooling the wheel speed sensor assembly 030 before exiting out the air shroud exit 540. By cooling the wheel speed sensor assembly 030, the wheel speed sensor with integrated temperature sensor 830 is also cooled.

The air line 230 connects the air spring 660 to the air spring pressure sensor with integrated temperature sensor 650. Signal wires 111 connect the air spring pressure sensor with integrated temperature sensor 650 to the wheel speed sensor and steering axle controller 010. The air spring 660 pressure is measured by the air pressure sensor with integrated temperature sensor 650. Electric current flowing through the air spring pressure sensor heating resister 651, heats the air spring pressure sensor with integrated temperature sensor 650. The heating of the air spring pressure sensor with integrated temperature sensor 650 is controlled by the wheel speed sensor and steering axle controller 010. The wheel speed sensor and steering axle controller 010, controls air spring pressure sensor heating resister 651 so the air spring pressure sensor with integrated temperature sensor 650 operators within its operating temperature range. The air spring pressure sensor heating resister 651 can use to prevent water freezing in or near to the air spring pressure sensor 650.

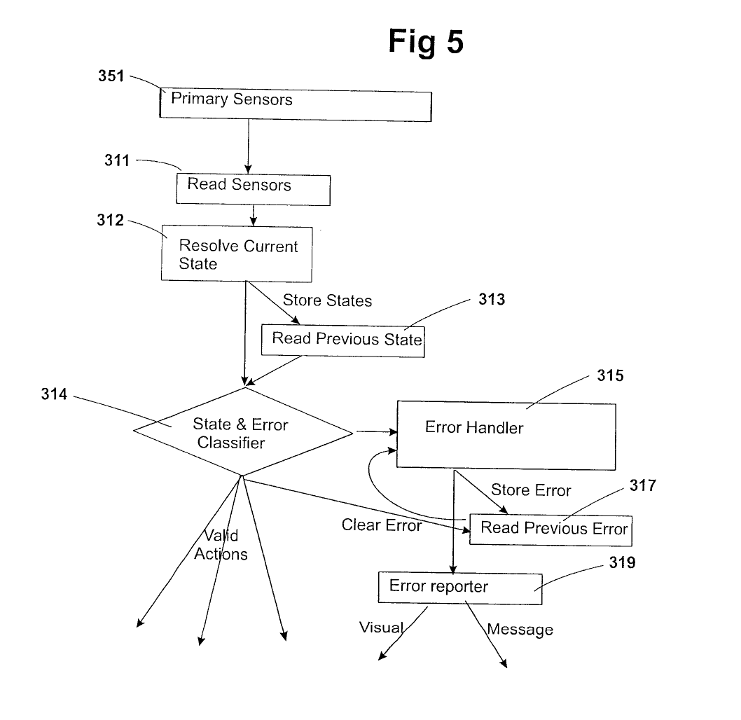

Solenoid power signal wires 121 connect the lift/lock axle control valves 042 to the controller 010. The wheel speed sensor and steering axle controller 010 uses the lift/lock axle control valves 042 to perform useful control of steering axles. This implementation of useful control by the wheel speed sensor controller 010, the steering axles are controlled to lifted, lowered and locked according to the Ontario, Canada SPIF requirements and is described in FIG. 5.

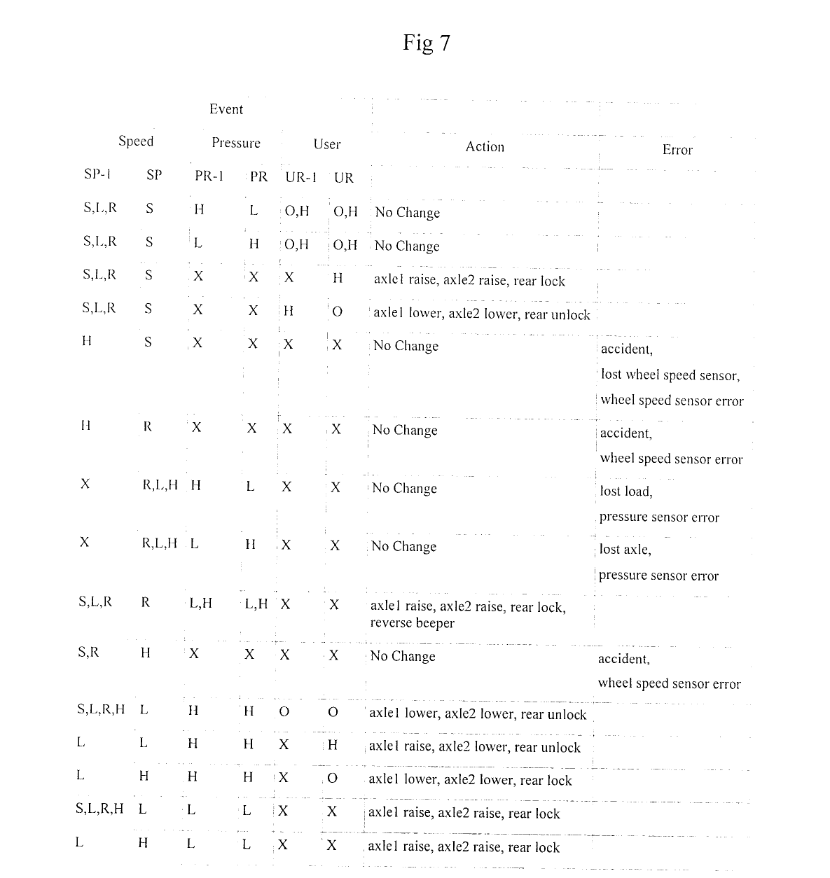

FIG. 5 refers to the main control logic loop of the wheel speed sensor controller 010 controlling steering axles according to the Ontario, Canada SPIF requirements. The control loop begins with the step of examining each of the primary sensors 351, magnetic wheel speed sensor 830 and air spring pressure sensor 650. The operator will provide user input by means of toggle switch or button. Then in the next step read sensors 311. The sensor readings are used in the next step to resolve current state 312 of the controlled system. The resolved current state is stored for use by the next pass of the main control loop. The resolved current state 312 and the read previous state 313 stored in previous pass of the main control loop are inputs to the State & Error Classifier 314. The State & Error Classifier 314 matches the current resolve state and the read previous state to a transition table present by FIG. 7 to select a valid action or error type. The error handler 315 examines the current error from the State & Error Classier 314 and Reads Previous Error 317 to determine the severity and type of error. The Error Reporter 319 indicates the severity and type of error visual and by message communicated for further analysis and logging.

FIG. 7 refers to the state transition table used by the State & Error Classifier 314 to select a valid action or error type according to the Ontario, Canada SPIF requirements. The state transition tables selects valid actions and error types according to the previous and current resolve states. The resolved states are determined according to the main control loop logic described in FIG. 5.

In the state transition table the current resolved speed state is SP and the stored previous resolved state is SP−1. The current resolved air spring pressure is PR and the stored previous resolved pressure state is PR−1. The current resolved user input state is UR and the previous resolved user input state is UR−1. The resolved speed states SP or SP−1 is:
S when the wheel speed sensor 830 detects the vehicle movement is less than 0.1 m in 20 seconds,
R when the wheel speed sensor 830 detects the vehicle has travelled more than 0.25 m in reverse,
L when the wheel speed sensor 830 detects the vehicle has moved more than 10 m forward and has remained below 57 km/hr or when the wheel speed sensor 830 detects the vehicle which has increased in speed beyond 57 km/hr and has reduced in speed below 55 km/hr,
H when the wheel speed sensor 830 detects the vehicle has increased in speed beyond 57 km/hr and has not reduced in speed below 55 km/hr.
   The resolved air spring pressure state PR or PR−1 is
H when the air spring pressure sensor 650 detects the vehicle weight has increased greater than a configured percentage of the trailer's maximum weight allowance, such as 85% and has not decreased below a configured percentage of the trailers' maximum weight allowance, such as 80%,
L when the air spring pressure sensor 650 detects the vehicle weight has not increased greater than the configured percentage of the trailer's maximum weight allowance, 85%,
   The resolved user input state UR or UR−1 is
H known as over ride when the user
   1) turned on the four-way flashers after they have been off for more than a set number of flashing periods, such as 2 periods
      then turned off the four-way flashers before a set number of flashing periods, such as 2 periods
   2) then turned on the four-way flashers before a set number of flashing periods, such as 2 periods
      then turned off the four-way flashers before a set number of flashing periods, such as 2 periods
   3) then turned on the four-way flashers before a set number of flashing periods, such as 2 periods
and the four-way flashers are left on,
O known as normal when the user turns off the four-way flashers or the wheel speed sensor 830 resolved the vehicle's current SP state is H.

The steering axles in front of the trailer's primary non-steerable axles do not require separate lock and unlock control. A steering axle behind the trailer's primary non-steerable axles has separate lock and unlock control. The steering axle behind the trailer's primary non-steerable axles is locked for high speed operation and unlocked for low speed operation. If the vehicle does not have a steering axle behind the trailer's primary non-steerable axles the solenoid power wires controlling the rear lock/unlock is left unconnected. If the trailer has only one steering axle in front of the trailer's primary non-steering axles, only the solenoid power wires controlling axle 1 are connected. If the trailer has only one steering axle and the steering axle is behind the trailer's primary non-steering axles, only the solenoid power wires controlling axle 2 are connected. When invalid state transitions occur, they are classified as errors and there is no change in the applied action commands.

The trailer weight can change when the trailer is stopped without error and is indicated by the following state transitions. The combined speed state transition from S or L or R to S and air spring pressure state transition from H to L and user state remains O or H occurs, the result is no action and no error is reported. The combined speed state transition from S or L or R to S and air spring pressure state transition from L to H and user state remains O or H occurs, the result is no action and no error is reported.

While stationary, the trailer lift axles can be lifted and lowered on command and is indicated by the following state transitions. The combined speed state transition S or L or R to S and any air spring pressure state transition and user transition from any user state to H results in the action commands axle 1 raise, axle 2 raise and rear lock. The combined speed state transition S or L or R to S and any air spring pressure state transition and user transition from any user state from H to O results in the action commands axle 1 lower, axle 2 lower and rear unlock.

If the trailer changes from high speed to stopped, an invalid state transition has occurred and state transition error indicates an accident has occurred or the wheel speed sensor has failed. This is indicated in the state transition table by the combined speed state transition H to S and any air spring pressure state transition and any user transition results in no change in applied action commands and the error is classified as accident, or lost wheel speed sensor, or wheel speed sensor error.

If the trailer changes from high speed to reverse, an invalid state transition has occurred and state transition error indicates an accident has occurred or the wheel speed sensor has failed. This is indicated in the state transition table by the combined speed state transition H to R and any air spring pressure state transition and any user transition results in no change in applied action commands and the error is classified as accident, or wheel speed sensor error.

While moving, significant changes in load on its air springs is an invalid state transition and state transition error indicates lost load, or an air spring/axle problem, or air spring pressure sensor has failed. This is indicated in the state transition table by the combined speed state from any state to a moving state R or L or H and air spring pressure state changes from H to L and any user transition results in no change in applied action commands and the error is classified as lost load or air spring pressure sensor error. Alternatively, the combined speed state from any state to a moving state R or L or H and air spring pressure state changes from L to H and any user transition results in no change in applied action commands and the error is classified as lost air spring/axle or air spring pressure sensor error.

When trailing in reverse, the trailer steering axles are lifted and locked and is indicated by the following state transitions. The combined speed state transition S or L or R to R and the air spring pressure state remains L or remains H, and user state transition results in the action commands axle 1 raise, axle 2 raise, and rear lock.

If the trailer changes from stopped or reverse to high speed, an invalid state transition has occurred and state transition error indicates an accident has occurred or the wheel speed sensor has failed. This is indicated in the state transition table by the combined speed state transition S or R to H and any air spring pressure state transition and any user transition results in no change in applied action commands and the error is classified as accident, or wheel speed sensor error.

When a loaded trailer is travelling at low speed, the steering axles are lowered and if there is a steering axle behind the trailer's primary non-steering axle, it is unlocked. This is indicated by the following state transitions. The combined speed state transition S or L or R or H to L and the air spring pressure state remains H, and user state transition results in the action commands axle 1 lower, axle 2 lower, and rear unlock.

When travelling at low speeds, the operator can lift the loaded trailer's front steering axle to apply more weight on the tractor's drive axle for improved traction. This is indicated by the following state transitions. The combined speed state transition L to L and the air spring pressure state remains H, and user state transition from any state to H results in the action commands axle 1 raise, axle 2 lower, and rear unlock.

When the loaded vehicle increases speed to high speed the controller exits the user state applied and lowers the trailer's front steering axle. This is indicated by the following state transitions. The combined speed state transition L to H and the air spring pressure state remains H, and any user state transition results in the state user state change to O and action commands axle 1 lower, axle 2 lower, and rear lock.

An unload trailer will keep all steering axles lifted. This is indicated by the following state transitions. The combined speed state transition S or L or R or H to L and the air spring pressure state remains L, and any user state transition results action commands axle 1 raise, axle 2 raise, and rear lock. The combined speed state transition L to H and the air spring pressure state remains L, and any user state transition results action commands axle 1 raise, axle 2 raise, and rear lock.

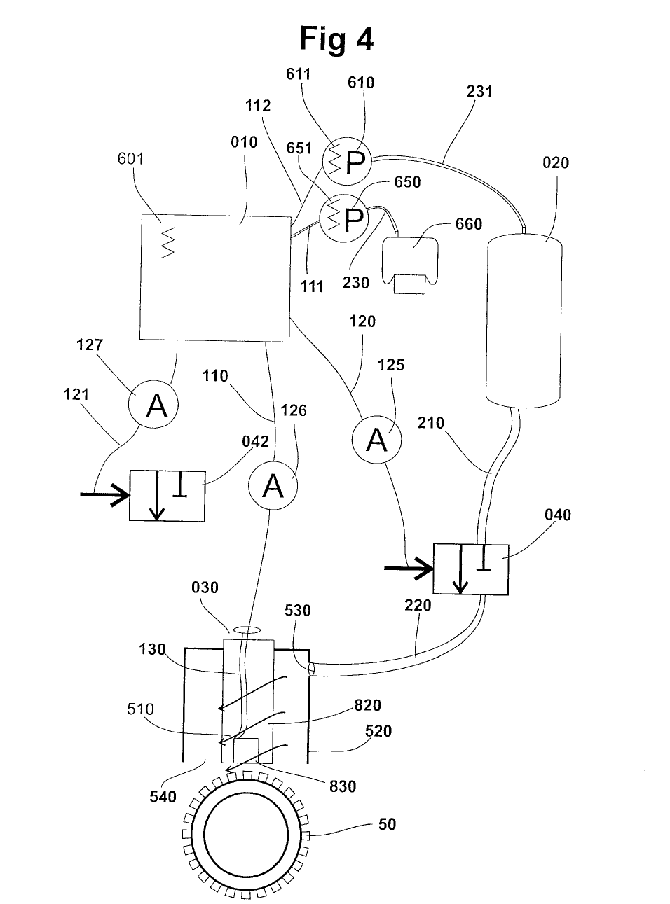

FIG. 4 is a diagrammatic view of the wheel speed sensor assembly 030 and wheel speed controller 010 with secondary sensors, active cooling, and lift/lock axle control valves.

The internal wheel speed and temperature signal wires 130 connect the wheel speed sensor with integrated temperature sensor 830 to the external signal wires 110. The current sensor 126 measures the wheel speed sensor 830 load current and provides the measurement to the controller 010. The wheel speed sensor assembly 030 temperature is measured by the wheel speed sensor with integrated temperature sensor 830. The measured wheel speed sensor assembly 030 temperature is communicated through signal wire 130 and 110 to the controller 010.

The internal wheel speed signal wires 130 are protected from the environment by electrical insulation 820. The magnetic wheel speed sensor with integrated temperature sensor 830 is located at the tip of the wheel speed sensor assembly 030 so that it is in close proximity to the magnetic encoder ring 050. The wheel speed sensor 831 is in close proximity to a magnetic encoder as required to provide a magnetic field strength sufficient for reliable detection of wheel speed. The wheel speed sensor assembly 030 is enclosed inside an air shroud 520. The air shroud 520 is the wheel speed sensor mounting encasement. An air line 220 is connected between the air shroud entrance 530 and the air flow valve 040. The air flow valve 040 is connected to the air supply 020 by an air line 210. The air flow valve 040 is opened and closed by its solenoid electrically connected to the wheel speed sensor controller 010, by solenoid power wires 120. The current sensor 125 measures the air flow valve 040 solenoid load current and provides the measurement to the controller 010.

The open air flow valve 040 allows air to flow from the pressurized air supply 020 through the air line 210, through the air valve 040, through the air line 220 into the air shroud 520 by the air shroud entrance 530. Air flow 510 from the air shroud entrance 530 circulates inside the air shroud 520, cooling the wheel speed sensor assembly 030 before exiting out the air shroud exit 540. By cooling the wheel speed sensor assembly 030, the wheel speed sensor with integrated temperature sensor 830 is also cooled.

The air line 230 connects the air spring 660 to the air spring pressure sensor with integrated temperature sensor 650. Signal wires 111 connect the air spring pressure sensor with integrated temperature sensor 605 to the wheel speed sensor controller 010. The air spring 660 pressure is measured by the air pressure sensor with integrated temperature sensor 650. The heating of the air spring pressure sensor with integrated temperature sensor 605 is controlled by the wheel speed sensor and steering axle controller 010. The air spring 660 pressure is measured by the air pressure sensor with integrated temperature sensor 650. Electric current flowing through the air spring pressure sensor heating resister 651, heats the air spring pressure sensor with integrated temperature sensor 650. The heating of the air spring pressure sensor with integrated temperature sensor 650 is controlled by the wheel speed sensor and steering axle controller 010. The wheel speed sensor and steering axle controller 010, controls air spring pressure sensor heating resister 651 so the air spring pressure sensor with integrated temperature sensor 650 operators within its operating temperature range. The air spring pressure sensor heating resister 651 can be used to prevent water freezing in or near to the air spring pressure sensor 650.

The air line 231 connects the air supply 020 to the air supply pressure sensor with integrated temperature sensor 610. Signal wires 112 connect the air supply pressure sensor with integrated temperature sensor 610 to the wheel speed sensor and steering axle controller 010. The air supply 020 pressure is measured by the air pressure sensor with integrated temperature sensor 650. Electric current flowing through the air supply pressure sensor heating resister 611, heats the air supply pressure sensor with integrated temperature sensor 610. The heating of the air supply pressure sensor with integrated temperature sensor 610 is controlled by the wheel speed sensor and steering axle controller 010.

Solenoid power signal wires 121 connect the lift/lock axle control valves 042 to the controller 010. The wheel speed sensor controller 010 uses the lift/lock axle control valves 042 to perform useful control of steering axles. In this implementation of useful control by the wheel speed sensor controller 010, the steering axles are controlled to be lifted, lowered and locked according to the Ontario, Canada SPIF requirements and is described in FIG. 5.

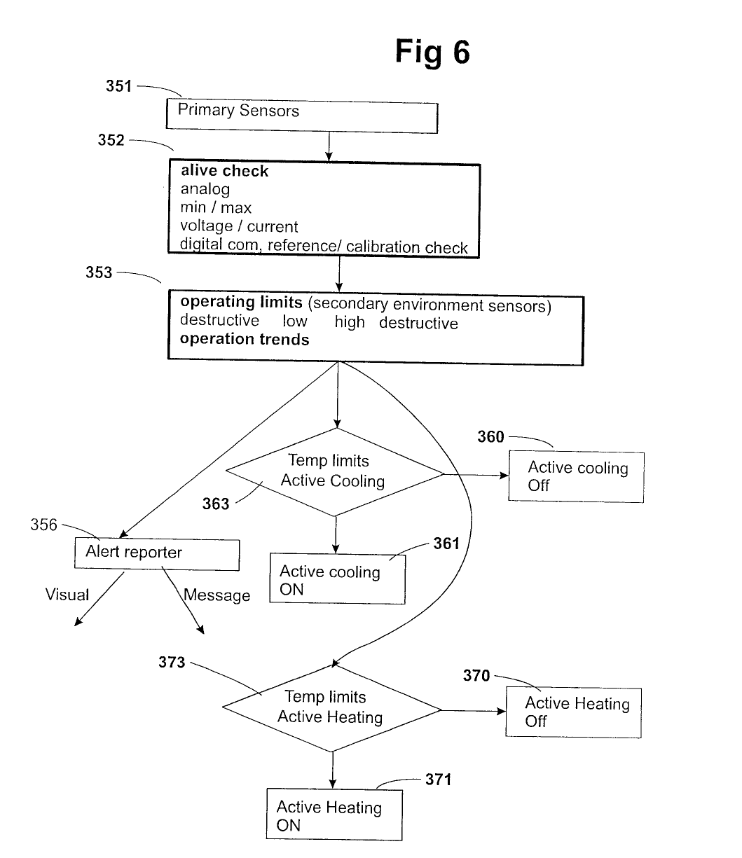

FIG. 6 refers to the primary sensor 351 alive checks 352, environment control logic and secondary environment sensors 353. The control loop begins with the step of examining each of the primary sensors 351, magnetic wheel speed sensor 830 and air spring pressure sensor 650. For each primary sensor 351 analog and/or digital alive checks are performed. Analog alive checks include measuring the sensor's current/voltage and determining where the sensor is operational between its minimum and maximum allowable current/voltage. Digital alive checks include communication with the digital sensor, usually verified by reading the sensor's id and reading a measurement from the sensor. Every sensor must operate within environmental constraints. The environment of the primary sensors 351 are measured by secondary environment sensors 353.

In designs where the wheel speed sensor 831 is in close proximity to the disc brake, prior art wheel speed sensor 831 will experience operating temperatures in excess of +150 C and will even experience operating temperatures in excess of +450 C.

The wheel speed sensor with integrated temperature sensor 830, measures the temperature of the wheel speed sensor 831. The wheel speed sensor controller 010, opens air flow valve 040 setting active cooling on 361, closes the air flow valve 040 setting active cooling off 361, according to the active cooling temperature limits 363. The wheel speed sensor controller 010 measures wheel speed sensor while integrated temperature sensor 830 measures temperature and rate of change, and measures the wheel speed and rate of change, to either predicatively determine when active cooling will likely be required or predicatively determine when active cooling will not be required. The wheel speed sensor controller 010 sets active cooling on 361 according to algorithmic prediction when active cooling is required to protect the wheel speed sensor with integrated temperature sensor 830 from over heating or sets active cooling off 360 according to algorithmic prediction when active cooling is not required to protect the wheel speed sensor with integrated temperature sensor 830 from over heating.

The alert reporter 356 informs the operator when active cooling is required, dangerously high temperatures are measured by the wheel speed sensor with integrated temperature sensor 830, and when destructive temperatures are measured by the wheel speed sensor with integrated temperature sensor 830. Through this information, the operator is able to adjust their driving style to reduce brake where and destructive brake heating.

The wheel speed sensor assembly 030 and wheel speed sensor controller 010, must endure harsh and environmental extremes of the far north where temperatures fall below −40 C and hot deserts where temperatures rise dangerously high. In hot desert conditions, any significant heat from electronics may result in catastrophic and destructive over heating of the wheel speed sensor controller 010 electronics.

The pressure sensors 610 and 650 are most sensitive to freezing and extreme cold. Air lines normally use dried air and anti-freeze. Unfortunately, moisture freezing can destroy the pressure sensors 610 and 650. To protect the pressure sensors 610 and 650, the wheel speed sensor controller 010 uses pressure sensor heaters 611 and 651 to prevent freezing. The wheel speed sensor controller 010 can use these pressure sensor heaters 611 and 651 that can evaporate dangerous moisture when damage to the pressure sensors 610 and 650 from freezing is likely to occur. The wheel speed sensor controller 010 monitors the daily extreme temperature measured by the pressure sensors with integrated temperatures 610 and 650. From these measured temperatures, wheel speed sensor controller 010 determines whether pressure sensor heaters 611 and 651 evaporation cycle is necessary to remove moisture which may have accumulated in the pressure sensors 610 and 650. The wheel speed sensor controller 010 uses the pressure sensor heaters 611 and 651 to prevent freezing temperatures occurring within the pressure sensors 610 and 650. By preventing freezing temperatures within the pressure sensors 610 and 650, the wheel speed sensor controller 010 also insures the wheel speed sensor controller 010 electronics never fall below −40 C.

The pressure sensors with integrated temperatures 610 and 650 measure their temperature and rate of temperature change. The wheel speed sensor controller 010 uses the pressure sensors 610 and 650 measured temperature and rate of temperature change to predicatively control the pressure sensor heaters 611 and 651 to insure pressure sensors 610 and 650 are not heated to exceed their maximum temperature, typically 85 C.

The alert reporter 356 informs the operator when active heating is required, dangerously low temperatures are measured by pressure sensors with integrated temperature sensor 610 and 650, and when potentially destructive freezing temperatures are measured by the pressure sensors with integrated temperature sensor 610 and 650. Through this information, the operator is able to adjust their maintenance to insure the air line has sufficient anti-freeze.

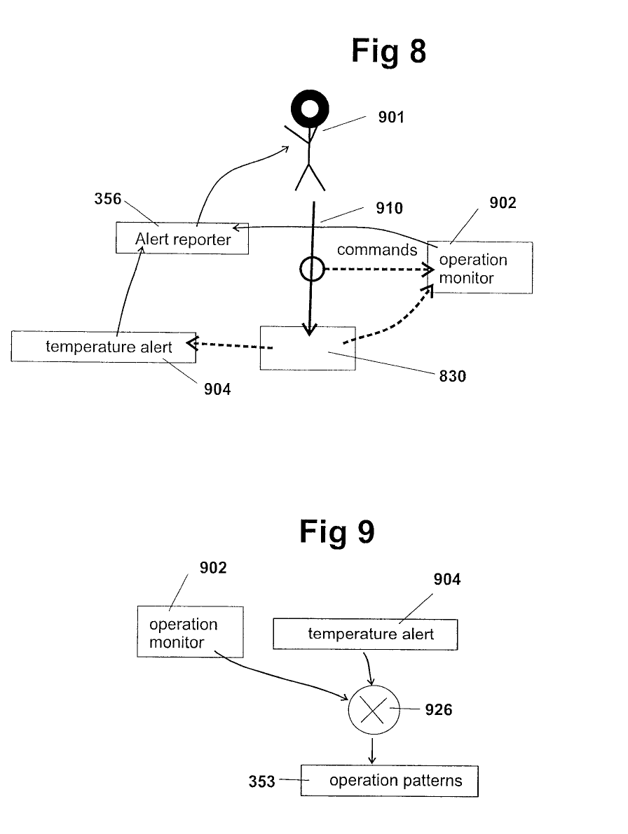

FIG. 8 refers to the operator's interaction with electronic automotive sensors with integrated temperature sensors 830. The operator 901 commands the automotive or machine to perform actions. These commands are sent through an interface 910 and are time stamped and monitored by an operation monitor 902. The effects of these commands are monitored by the electronic automotive sensor with integrated temperature sensor 830. The electronic automotive sensor measurements are time stamped and monitored by the operation monitor 902. The temperature recorded by the temperature sensor in proximity to the electronic automotive sensor is time stamped and monitored by the temperature alert monitor 904. Measurements collected by the operation monitor 902 and temperatures collected by the temperature alert monitor 904 are processed by the alert reporter 356. The alert reporter 356 classifies the measurements collected and temperatures collected according to the operation patterns 353 obtained as illustrated in FIG. 9. The operation patterns 353, which are used by the alert reporter 365 to classify the measurements, were previously trained or obtained by other machine learning approaches. The alert reporter 356 alerts the operator of operating behaviour that has been determined by classification of collected operator commands, electronic sensor measurements, and temperature measurements that are likely to result in measurable degraded performance or the sensor temperature environment outside the sensor temperature operating range. The alert reporter 356 also maintains a record of events classified as likely to result in measurable degraded performance or the sensor temperature environment outside the sensor temperature operating range. These collected predictive events and measured events are used to verify the accuracy of the predicted events and improve the machine learning used to obtain the operation patterns 353, which are in turn used to provide more accurate predictive events. Predictive events of electrical or mechanical faults, such as low air pressure, failed wheel speed sensor, and brake wear, provide the operator an opportunity to perform preventive maintenance at a convenient time and place.

FIG. 9 refers to the process of classifier training and machine learning to create the operation patterns 353, which are used by the alert reporter of FIG. 8. Data collected by many operation monitors 902 and many temperature alert monitors 904 are used to predict events not previously experienced by the operator 901. Data is wirelessly collected from the operation monitor 902 and temperature alert monitor 904 and transferred over the Internet to one or more centralized classifier training and machine learning processors 926. The trained operation patterns 353 are received by the remote alert reporters 356. Candidate centralized machine learning tools and services include RapidMiner, LIONsolver, Azure Machine Learning, Google Prediction API and others. RapidMiner was chosen as the centralized learning processor used to model and train operation patterns 353. Predictive Maintenance is application of operation patterns 353.

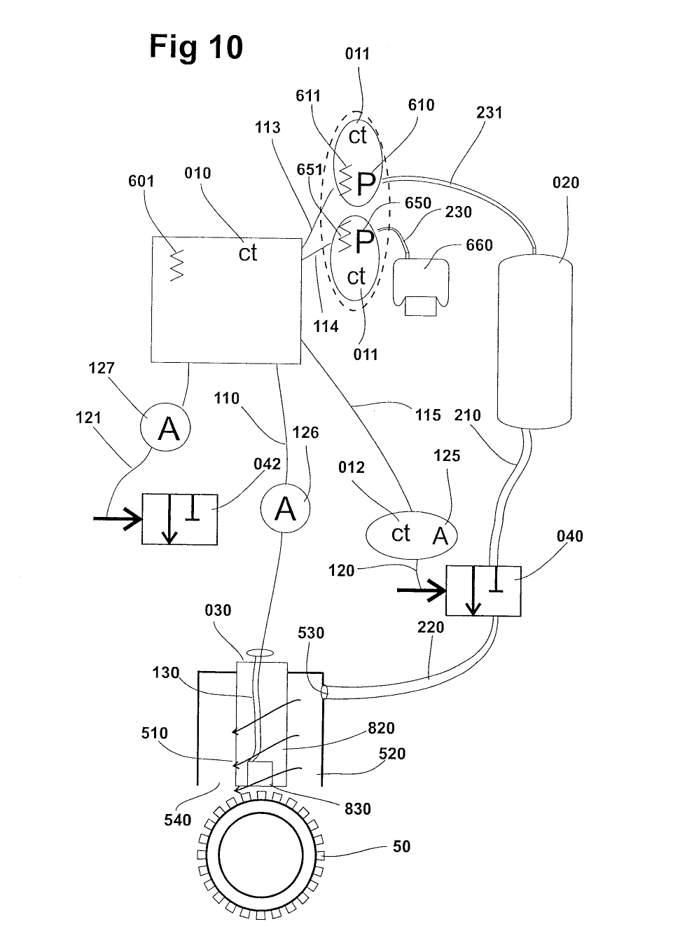

FIG. 10 is a diagrammatic view of the wheel speed sensor assembly 030 and wheel speed controller 010 with secondary sensors, active cooling, and lift/lock axle control valves with distributed resistive heater controllers 011 and active cooling air flow controllers 012. In FIG. 8 the supply resistive heater control function is separated and moved from the wheel speed and steering axle controller 010 to be the resistive heater controller 011 associated with the supply pressure sensor heating resistor 611. Similarly, the air spring resistive heater control function is separated and moved from the wheel speed and steering axle controller 010 to be the resistive heater controller 011 associated with the air spring pressure sensor heating resistor 651. The resistive heater controller 011 associated with the supply pressure sensor heating resistor 611 communicates with the wheel speed and steering axle controller 010 by communication wires 113 connecting the controllers together. The resistive heater controller 011 associated with the air spring pressure sensor heating resistor 651 communicates with the wheel speed and steering axle controller 010 by communication wires 113 connecting the controllers together. In the diagrammatic view shown in FIG. 8, the supply pressure sensor with integrated temperature sensor 610 and the supply pressure sensor heating resistor 611 are in proximity to the air spring pressure sensor with integrated temperature sensor 650 and air spring pressure sensor heating resistor 651. As a result, the integrated temperature sensor 610 is able to estimate the temperature of the air spring pressure sensor with integrated temperature sensor 650 and the integrated temperature sensor 650 is able to estimate the temperature of the supply pressure sensor with integrated temperature sensor 610. As a result, the supply pressure sensor heating resistor 611 indirectly heats the air spring pressure sensor with integrated temperature sensor 650. In turn, air spring pressure sensor heating resistor 651 indirectly heats the supply pressure sensor with integrated temperature sensor 610. If the resistive heater controller 011 associated with the supply pressure sensor heating resistor 611 fails, the resistive heater controller 011 associated with the air spring pressure sensor heating resistor 651 is able to indirectly control the temperature of the supply pressure sensor with integrated temperature sensor 610. As result of proximity, the resistive heater controller 011 associated with the air spring pressure sensor heating resistor 651 is able to provide redundancy for resistive heater controller 011 associated with the supply pressure sensor heating resistor 611. If the temperature sensor of air spring pressure sensor with integrated temperature sensor 650 fails, the supply pressure sensor with integrated temperature sensor 610 is able to estimate the temperature of supply pressure sensor with integrated temperature sensor 610. As a result, the temperature sensors are able to provide redundancy for each other.

The active cooling air flow control function is separated and moved from the wheel speed and steering axle controller 010 to be the active cooling air flow controller 012 and moved closer to the air flow control valve 040 that it is controlling. The length of the solenoid power wires 120 are significantly shortened. The active cooling air flow controller 012 communicates with the wheel speed and steering axle controller 010 by communication wires 115 connecting it to the wheel speed and steering axle controller 010.

Although the invention has been described and shown with reference to specific preferred embodiments, it should be understood by those who are skilled in the art that some modification in form and detail may be made therein without deviating from the spirit and scope of the invention as defined in the following claims. Thus the scope of the invention should be determined not by the embodiments illustrated, but by the appended claims and their legal equivalents.

We claim:

1. A system to monitor and control environmental temperature of an electronic automotive sensor, comprising
(a) a sensor assembly having the electronic automotive sensor and a temperature sensor that are located in proximity to each other,
(b) means for actively cooling or heating the electronic automotive sensor according to a temperature operating range of the electronic automotive sensor, the electronic automotive sensor being located on a motor vehicle,
(c) a controller that uses the temperature sensor to monitor the temperature of the electronic automotive sensor and acts to control the means of actively cooling or heating the electronic automotive sensor to maintain said electronic automotive sensor within its temperature operating range,
whereby damage to the electronic automotive sensor and measurement inaccuracy caused by temperatures outside the temperature operating range of the electronic automotive sensor is reduced by said controller controlling the means of actively cooling or heating the electronic automotive sensor.

2. The system as claimed in claim 1 wherein the electronic automotive sensor is a wheel speed sensor and the means of actively cooling or heating the electronic automotive sensor acts indirectly by cooling or heating a first component that is cooling or heating respectively the electronic automotive sensor,
whereby the cooling or heating of the first component that is cooling or heating the electronic automotive sensor reduces extreme temperature damage to said first component and the electronic automotive sensor.

3. The system as claimed in claim 1 further comprising a means of reporting through which the controller alerts an operator when the temperature of the electronic automotive sensor is outside the temperature operating range of the electronic automotive sensor,
whereby providing an operator with feedback of temperature conditions that may damage the electronic automotive sensor allows an operator to reduce the occurrence of events that result in damaging temperature conditions,
whereby possible damage to the electronic automotive sensor is detected, thereby allowing for longer periods between manual maintenance inspections required to validate reliable operation of the electronic automotive sensor.

4. The system as claimed in claim 1 wherein the electronic automotive sensor is an electronic magnetic sensor located in a contained area with the temperature sensor in proximity to a second component, such that the magnetic sensor determines the relative position of the second component by means measuring the magnetic field of the second part, wherein the means of actively cooling or heating the electronic automotive sensor is a fluid flowing from a fluid supply through the contained area or by the contained area, and wherein the controller acts to control the fluid flow to keep the magnetic sensor within its operating temperature range,
whereby possible damage to the electronic magnetic sensor caused by temperatures outside the temperature range of the magnetic sensor is reduced by the controller acting to control the fluid flowing through the contained area or by the contained area, containing the magnetic sensor.

5. The system as claimed in claim 1 wherein the electronic automotive sensor is a fluid sensor measuring pressure or flow located in a shroud with the temperature sensor, wherein the means of actively heating the electronic automotive sensor is an electric heater located in proximity to the contained area, and wherein the controller acts to control the electric heater to keep the fluid sensor within its operating temperature range,
whereby possible damage to the fluid sensor or inaccurate reporting by the fluid sensor caused by temperatures outside the temperature range of the fluid sensor is reduced by the controller acting to control the electric heater in proximity to the fluid sensor in the contained area.

6. The system as claimed in claim 2 wherein the wheel speed sensor is an electronic magnetic sensor, wherein the means of actively cooling the electronic automotive sensor indirectly cools the electronic magnetic sensor by cooling the brakes that are heating the electronic magnetic sensor, and wherein the controller acts to control cooling of the brakes,
whereby the indirectly cooling the electronic magnetic sensor by cooling the brakes that is heating the electronic magnetic sensor reduces extreme high temperature damage to said brakes and the electronic magnetic sensor.

7. The system as claimed in claim 2 wherein the electronic automotive sensor is a fluid sensor measuring fluid pressure or flow, wherein the means of actively cooling or heating the air fluid sensor indirectly cools or heats the fluid sensor by actively cooling or heating the electronic circuit board attached to the fluid sensor, and wherein the controller acts to control heating or cooling of the electronic circuit board,
whereby the indirect heating or cooling of the fluid sensor by heating or cooling the electronic circuit board that is cooling or heating the fluid sensor reduces extreme temperature damage to the complete system of the fluid sensor and the electronic circuit board attached to the fluid sensor.

8. The system as claimed in claim 1 wherein the controller has two subcontrollers, wherein a first subcontroller monitors the temperature, wherein the first subcontroller communicates with a second subcontroller, and wherein the second subcontroller acts to control the means of actively cooling or heating the electronic automotive sensor,
whereby separation of the controller into the subcontrollers enables distributed monitoring of the electronic automotive sensor by the temperature sensor in proximity to the electronic automotive sensor and enables distributed control of distributed means of actively cooling or heating the electronic automotive sensor,
whereby when the automotive sensor and said means of actively cooling said sensor are widely separated, temperature monitoring may be improved by a nearby subcontroller and control of the means of actively cooling or heating the automotive sensor may be improved by a nearby subcontroller.

9. The system as claimed in claim 8 further including redundancy of said subcontrollers, whereby the reliability of the system is improved through redundancy in case there are one or more component failures.

10. The system as claimed in claim 1 comprising a means of reporting through which the controller alerts an operator when the temperature of the electronic automotive sensor is approaching limits of the temperature operating range of the electronic automotive sensor,
whereby providing a operator with feedback allows an operator to reduce the currents of event that will result in damaging temperature conditions,
whereby possible damage to said electronic automotive sensor is detected before any damage occurs, thereby allowing for longer periods between manual maintenance inspections required to validate reliable operation of the electronic automotive sensor.

11. The system as claimed in claim 1 wherein there are:
(a) means of recording automotive operation measured by the electronic automotive sensors;
(b) means of recording temperature measured by the temperature sensor;
(c) means of analyzing recorded automotive operation and recorded temperatures to uncover patterns and correlating the recorded automotive operation with the temperatures of the electronic automotive sensors to determine when the temperature of any electronic automotive sensor is outside of the temperature operating range of the particular electronic automotive sensor and measuring degraded performance by the electronic automotive sensor, the analysis being conducted using a programmable controller;
(d) means of using patterns to classify the temperature sensor measurements and the electronic automotive sensor measurements according to the probability of the electronic automotive sensor temperature being outside the temperature operating range of any of the electronic automotive sensors and measuring degraded performance of the electronic automotive sensors;
whereby recorded automotive operations measured by the electronic automotive sensors of temperatures measured by the temperature sensors are used to determine the probability of having degraded performance of automotive operations in the electronic automotive sensors operating outside the temperature range.

12. The system as claimed in claim 1 wherein there is more than one electronic automotive sensor and corresponding temperature sensor.

13. The system as claimed in claim 12 wherein the electronic automotive sensors are a wheel speed sensor and a pressure sensor.

14. A method of operating a system to monitor and control the environmental temperature of automotive sensors having a sensor assembly with an electronic automotive sensor and temperature sensor located in proximity to each other, with means of actively cooling or heating the electronic automotive sensor according to a temperature operating range of the electronic automatic sensor, with a controller to operate and control the system, the method comprising having the controller use the temperature sensor to monitor the temperature of the electronic automotive sensor and activating the means to cool or heat the electronic automotive sensor to maintain the electronic automotive sensor within its temperature operating range, thereby reducing any damage to the electronic automotive sensor that would be caused by operating at temperatures outside the temperature operating range.

15. The method as claimed in claim 14 including the steps of:
(a) recording automotive operation measured by the electronic automotive sensors;
(b) recording temperature measured by the temperature sensor;
(c) uncovering patterns in recorded automotive operation correlating with temperatures of any of the electronic automotive sensors to operating outside a temperature operating range of that sensor and degraded performance by the automotive operation measured by the electronic automotive sensor; and
(d) pattern matching measurements of the temperature sensor and of the electronic automotive sensor according to a probability of an electronic automotive sensor temperature being outside the temperature operating range of the electronic automotive sensor being measured and determining whether there is any degraded performance of any of the electronic automotive sensors.
